(19) United States
(12) Patent Application Publication
(10) Pub. No.: US 2025/0102093 A1
(43) Pub. Date: Mar. 27, 2025

(54) MULTI-FIT PIPE ADAPTER

(71) Applicant: ADVANCED DRAINAGE SYSTEMS, INC., Hilliard, OH (US)

(72) Inventors: Christopher MORAN, Columbus, OH (US); Karim MAHRAZ, Willoughby, OH (US); Joshua CISLO, Findlay, OH (US)

(73) Assignee: ADVANCED DRAINAGE SYSTEMS, INC., Hilliard, OH (US)

(21) Appl. No.: 18/473,680

(22) Filed: Sep. 25, 2023

(51) Int. Cl. F16L 41/12; E03F 3/04

(52) U.S. Cl. CPC F16L 41/12; E03F 3/04

(57) ABSTRACT

Embodiments of the present disclosure provide a stormwater drainage system including a multi-fit adapter for connecting at least one fluid pipe to a fluid basin. The multi-fit adapter may include a plate configured to be mounted on an outer surface of the fluid basin; and a plurality of concentric rings protruding from the plate. In disclosed embodiments, a curvature of the plate may correspond to a curvature of the outer surface of the fluid basin. In disclosed embodiments, each of the plurality of concentric rings may be configured to accommodate a fluid pipe.

### TECHNICAL FIELD

This disclosure relates generally to stormwater drainage systems, and more particularly, to catch basins for accumulating stormwater and for conveying the stormwater to at least one fluid pipe.

### BACKGROUND

Catch basins are an important component in a stormwater drainage system. They are strategically placed underground to collect stormwater to prevent flooding of pavement, landscaping, and property. During a rain event, stormwater flows through a drain into the catch basin, which may connect to one or more fluid drainage pipes. As the catch basin fills, the drainage pipe may remove the water from the basin and carry the water downstream to a sewer system or to a body of water, such as a river or ocean.

Currently, catch basins are manufactured with one or more precast openings for connection to a pipe, such as a drainage pipe. This practice creates two problems for users. First, the precast openings are only suitable for use with pipes of a specific corresponding size. Any pipes that are larger or smaller than that corresponding size will not fit with the precast opening and therefore cannot be used with the catch basin. Second, the user of the catch basin is prevented from adjusting or moving the connection point for the pipe (i.e., the precast opening) since the opening's location is predetermined by the manufacturer. As a result, users are prevented from customizing the arrangement of the catch basin and pipe(s) to better suit their needs.

Therefore, there is a need for a catch basin that can be securely connected to fluid pipes of different sizes. Additionally, there is a need for a catch basin that allows the end user to select the location of an outlet opening on the basin and to easily connect a fluid pipe at the selected location.

### SUMMARY

Consistent with disclosed embodiments, systems, assemblies, apparatuses, and methods related to fluid collection and storage are disclosed. According to an embodiment of the present disclosure, a multi-fit adapter for a fluid basin is provided. The multi-fit adapter includes a plate configured to be mounted on an outer surface of the fluid basin; and a plurality of concentric rings protruding from the plate. In disclosed embodiments, a curvature of the plate corresponds to a curvature of the outer surface of the fluid basin. In disclosed embodiments, each of the plurality of concentric rings is configured to accommodate a fluid pipe.

In disclosed embodiments, the plurality of concentric rings protrude from a curved first surface of the plate. In disclosed embodiments, a second surface of the plate is configured to be positioned flush with the outer surface of the fluid basin. In disclosed embodiments, the multi-fit adapter is configured to be affixed to the outer surface of the fluid basin to provide a fluid-tight connection between the fluid pipe and an interior volume of the fluid basin. In disclosed embodiments, the at least one concentric ring includes an internal surface of a first diameter and an external surface of a second diameter. The internal surface of the at least one concentric ring may be configured to couple to the fluid pipe. Additionally, or alternatively, the external surface of the at least one concentric ring may be configured to couple to the fluid pipe. In disclosed embodiments, the concentric rings are configured to couple to fluid pipes of different sizes. In disclosed embodiments, the plate is configured to be mounted on the outer surface of the fluid basin at any position along the circumference of the fluid basin. In disclosed embodiments, the plate is configured to be positioned over a fluid opening in a side wall of the fluid basin. In disclosed embodiments, the plate includes a center portion at a position corresponding to a center of the concentric rings. The multi-fit adapter may be configured for formation of a fluid opening in the center portion of the plate. In disclosed embodiments, the plate and the plurality of concentric rings are constructed from the same material. In disclosed embodiments, the fluid basin has an outer diameter of approximately 24 inches. In disclosed embodiments, at least one of the plurality of concentric rings is configured to accommodate a pipe for delivering fluid into the fluid basin. In disclosed embodiments, at least one of the plurality of concentric rings is configured to accommodate a pipe for draining fluid from the fluid basin.

According to another embodiment of the present disclosure, a customizable fluid basin configured to connect to fluid pipes of different sizes is provided. The fluid basin includes a cylindrical side wall having an inner surface and an outer surface. In disclosed embodiments, at least a portion of the outer surface of the cylindrical side wall is embossed with a grid design designating a plurality of locations configured to receive a multi-fit adapter on the outer surface of the fluid basin, the multi-fit adapter being configured to accommodate fluid pipes of different sizes. In disclosed embodiments, the fluid basin is configured to receive fluid from or deliver fluid to a fluid pipe connected to the multi-fit adapter via at least one opening in the cylindrical side wall of the fluid basin.

In disclosed embodiments, the cylindrical side wall of the fluid basin is configured to accommodate a plurality of multi-fit adapters for fluidly connecting to a plurality of fluid pipes. In disclosed embodiments, the cylindrical side wall of the fluid basin is configured to receive the multi-fit adapter at any position along the circumference of the cylindrical side wall. In disclosed embodiments, the fluid basin additionally includes a bottom portion of the fluid basin at an end of the cylindrical side wall; and at least one reinforcing rib on the bottom portion. In disclosed embodiments, the fluid basin has an outer diameter of approximately 24 inches.

According to another embodiment of the present disclosure, a method of assembling a fluid drainage system is provided. The fluid drainage system includes a fluid basin and at least one fluid pipe for connecting to the fluid basin. The method includes forming at least a first fluid opening in the fluid basin; forming a second fluid opening in a multi-fit adapter, the multi-fit adapter having a plurality of concentric rings configured to accommodate fluid pipes of different sizes; mounting the multi-fit adapter on an outer surface of the fluid basin; and connecting a first selected fluid pipe to a corresponding one of the concentric rings to form a first fluid path between the fluid basin and the first selected fluid pipe through the first fluid opening and second fluid opening.

In disclosed embodiments, the multi-fit adapter additionally includes a plate configured to be mounted on the outer surface of the fluid basin, the plurality of concentric rings protruding from the plate. In disclosed embodiments, a curvature of the plate corresponds to a curvature of the outer surface of the fluid basin. In disclosed embodiments, the plurality of concentric rings protrude from a curved first surface of the plate. In disclosed embodiments, a second surface of the plate is configured to be positioned flush with the outer surface of the fluid basin. In disclosed embodiments, the second fluid opening is formed in a center portion of the plate, at a position corresponding to a center of the concentric rings. In disclosed embodiments, mounting the multi-fit adapter on the fluid basin includes positioning the multi-fit adapter to overlay the first fluid opening in the fluid basin. In disclosed embodiments, the method additionally includes affixing the multi-fit adapter to the outer surface of the fluid basin to form a fluid-tight connection between the multi-fit adapter and the fluid basin. In disclosed embodiments, the second fluid opening is formed in the multi-fit adapter before mounting the multi-fit adapter on the fluid basin. In alternative embodiments, the second fluid opening is formed in the multi-fit adapter after mounting the multi-fit adapter on the fluid basin. In disclosed embodiments, the first selected fluid pipe is configured to deliver fluid to the fluid basin through the first fluid opening and second fluid opening. In disclosed embodiments, the first selected fluid pipe is configured to drain fluid from the fluid basin through the first fluid opening and second fluid opening.

In disclosed embodiments, the method of assembling a fluid drainage system additionally includes forming a third fluid opening in the fluid basin; mounting a second multi-fit adapter on the outer surface of the fluid basin; forming a fourth fluid opening in the second multi-fit adapter; and connecting a second selected fluid pipe to a corresponding concentric ring of the second multi-fit adapter to form a second fluid path between the fluid basin and the second selected fluid pipe through the third fluid opening and fourth fluid opening. In disclosed embodiments, the first selected fluid pipe and the second selected fluid pipe have different diameters. In disclosed embodiments, the fluid basin has an outer diameter of approximately 24 inches.

The forgoing summary provides certain examples of disclosed embodiments to provide a flavor for this disclosure and is not intended to summarize all aspects of the disclosed embodiments. Additional features and advantages of the disclosed embodiments will be set forth in part in the description that follows, and in part will be apparent from the description, or may be learned by practice of the disclosed embodiments. The features and advantages of the disclosed embodiments will be realized and attained by the elements and combinations particularly pointed out in the appended claims.

It is to be understood that both the foregoing general description and the following detailed description are examples and explanatory only and are not restrictive of the disclosed embodiments as claimed.

The accompanying drawings constitute a part of this specification. The drawings illustrate several embodiments of the present disclosure and, together with the description, serve to explain the principles of the disclosed embodiments as set forth in the accompanying claims.

### BRIEF DESCRIPTION OF THE DRAWINGS

The accompanying drawings, which are incorporated in and constitute a part of this specification, illustrate disclosed embodiments and, together with the description, serve to explain the disclosed embodiments.

FIG. 1A is a front perspective view of an example of a multi-fit adapter for a fluid basin, consistent with disclosed embodiments.

FIG. 1B is a rear perspective view of the multi-fit adapter of FIG. 1A, consistent with disclosed embodiments.

FIG. 1C is a front elevation view of the multi-fit adapter of FIG. 1A, consistent with disclosed embodiments.

FIG. 1D is a top plan cross-sectional view of the multi-fit adapter of FIG. 1A, as indicated in FIG. 1C.

FIG. 2A is a cross-sectional view of an example of a multi-fit adapter accommodating a fluid pipe, consistent with disclosed embodiments.

FIG. 2B is a cross-sectional view of another example of a multi-fit adapter accommodating a fluid pipe, consistent with disclosed embodiments.

FIG. 2C is a cross-sectional view of a further example of a multi-fit adapter accommodating a fluid pipe, consistent with disclosed embodiments

FIG. 3A is a front perspective view of another example of a multi-fit adapter for a fluid basin, consistent with disclosed embodiments.

FIG. 3B is a top plan cross-sectional view of the multi-fit adapter of FIG. 3A, as indicated in FIG. 3A.

FIG. 4A is a front perspective view of an example of a fluid basin, consistent with disclosed embodiments.

FIG. 4B is a bottom plan view of the fluid basin of FIG. 4A, consistent with disclosed embodiments.

FIG. 5 illustrates a fluid drainage system including a multi-fit adapter for a fluid basin, consistent with disclosed embodiments.

FIG. 6 is an exploded view of the fluid drainage system of FIG. 5, consistent with disclosed embodiments.

FIG. 7 illustrates another fluid drainage system including two multi-fit adapters for a fluid basin, consistent with disclosed embodiments.

FIG. 8 is a flow chart illustrating an example of assembling a fluid drainage system, consistent with disclosed embodiments.

FIG. 9 is a flow chart illustrating another example of assembling a fluid drainage system, consistent with disclosed embodiments.

### DETAILED DESCRIPTION

Examples of embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It should also be noted that as used in the present disclosure and in the appended claims, the singular forms “a,” “an,” and “the” include plural references unless the context clearly dictates otherwise.

As used herein, the phrases “for example,” “such as,” “for instance” and variants thereof describe non-limiting embodiments of the presently disclosed subject matter. Reference in the specification to features of “embodiments,” “examples,” “one case,” “some cases,” “other cases” or variants thereof means that a particular feature, structure or characteristic described may be included in at least one embodiment of the presently disclosed subject matter. Thus the appearance of such terms does not necessarily refer to the same embodiment(s). As used herein, the term “and/or” includes any and all combinations of one or more of the associated listed items. As used herein, the expression “at least one of . . . or” may include each listed item individually or any combination of the listed items. For example, the expression “at least one of A, B, or C” may include any of A, B, or C alone or any combination of A, B, and C (e.g., A+B, A+C, B+C, or A+B+C).

Features of the presently disclosed subject matter, are, for brevity, described in the context of particular embodiments. However, it is to be understood that features described in connection with one embodiment are also applicable to other embodiments. Likewise, features described in the context of a specific combination may be considered separate embodiments, either alone or in a context other than the specific combination.

Examples of the presently disclosed subject matter are not limited in application to the details of construction and the arrangement of the components set forth in the following description or illustrated in the drawings. The subject matter may be practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing may have the same use and description as in the previous drawings.

The drawings in this document may not be to any scale. Different figures may use different scales and different scales can be used even within the same drawing, for example different scales for different views of the same object or different scales for the two adjacent objects.

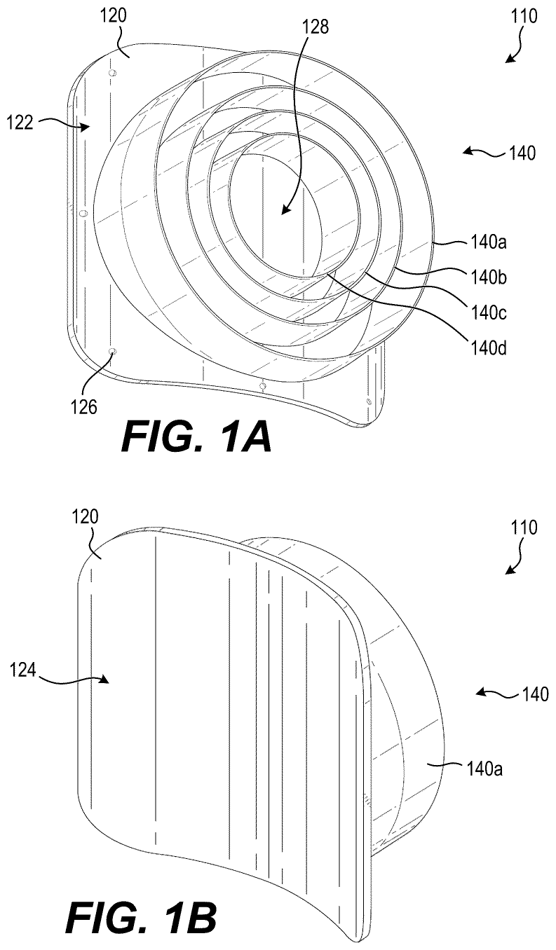

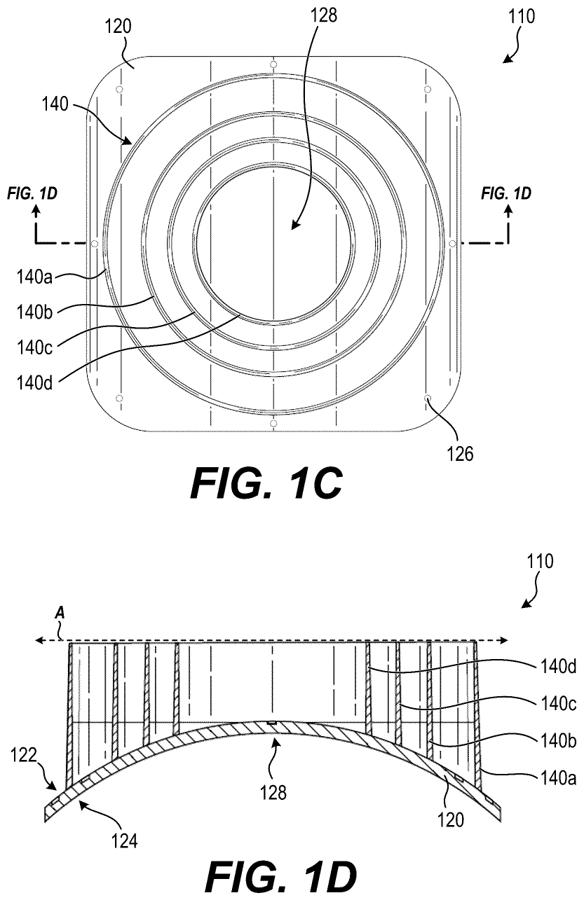

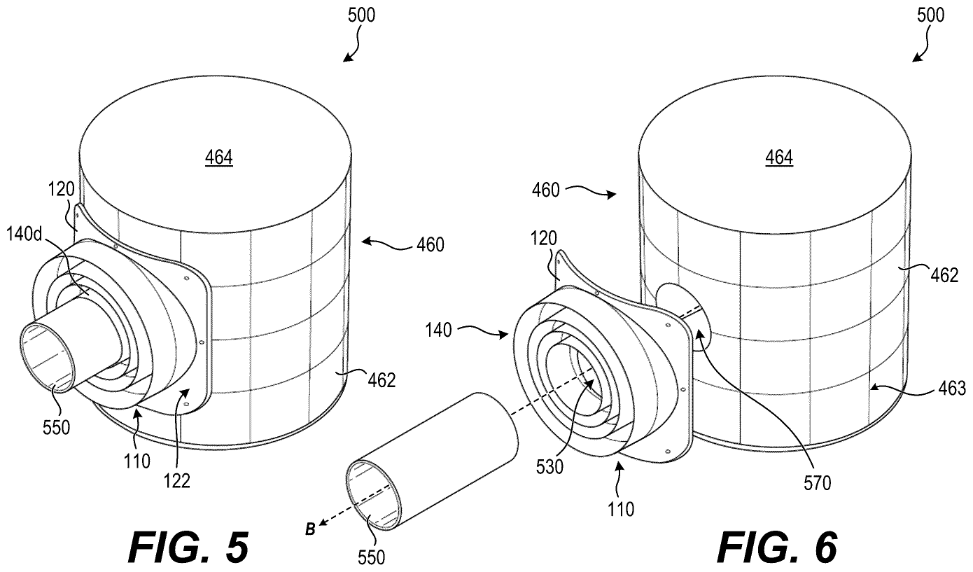

FIGS. 1A-1D depict a first embodiment of a multi-fit adapter 110. Adapter 110 may be configured to be secured to a fluid basin or container (e.g., a stormwater catch basin) and may provide a fluid connection between the basin or container and at least one fluid pipe. The fluid pipe may be configured to deliver fluid to and/or remove fluid from the fluid basin. In some embodiments, the adapter 110 includes a plate 120 configured to be mounted on an outer surface of the fluid basin. The plate 120 may have a thin, relatively flat body and may be formed from a material such as plastic, polyvinyl chloride (PVC), corrugated polyethylene, corrugated polypropylene, fiberglass, or a thermoplastic polymer (e.g., acrylonitrile butadiene styrene (ABS)). For example, adapter 110 shown in FIGS. 1A-1D includes plate 120 having a curved front surface 122 and a curved rear surface 124. In some embodiments, the plate 120 may be curved such that a curvature of the plate 120 corresponds to a curvature of the outer surface of the fluid basin. For example, the curvature of the plate 120 may be equal or substantially equal to the curvature of the outer surface of the fluid basin. As a result, when plate 120 is mounted on the fluid basin, the rear surface 124 of the plate is flush with the basin's outer surface. An example of this arrangement is depicted in FIG. 5, which shows a fluid drainage system 500 including an adapter 110 and a fluid basin 460. As FIG. 5 shows, the rear surface of adapter 110 may be flush with the outer surface of the fluid basin's sidewall 462, with the adapter's front surface 122 facing away from the basin 460. In some embodiments, plate 120 may include one or more openings 126 to accommodate fasteners for securing plate 120 to the fluid basin 460.

Multi-fit adapter 110 may additionally include a plurality of concentric rings 140 protruding from the curved front surface 122 of plate 120, with a center plate portion 128 arranged in the center of the concentric rings. In some embodiments, the plurality of concentric rings 140 may be constructed from the same material as the plate 120 or, alternatively, from a different material. In the example shown, adapter 110 includes four concentric rings 140a, 140b, 140c, and 140d. However, other embodiments of the multi-fit adapter may include more or fewer concentric rings. For example, the multi-fit adapter may include two rings, three rings, four rings, five rings, eight rings, ten rings, or any other suitable number of concentric rings. The concentric rings 140a-140d may have increasingly larger diameters, with the outer-most ring 140a having the largest diameter and the inner-most ring 140d having the smallest diameter. For example, concentric ring 104d may have a smaller diameter than concentric ring 104c, concentric ring 104c may have a smaller diameter than concentric ring 104b, and concentric ring 104b may have a smaller diameter than concentric ring 104a. The plurality of concentric rings 104a-d may have diameters in a range between about 4 inches to about 36 inches. For example, concentric rings 104a-d may have diameters of about 4 inches, 6 inches, 8 inches, 10 inches, 12 inches, 14 inches, 15 inches, 16 inches, 18 inches, 21 inches, 24 inches, or 36 inches.

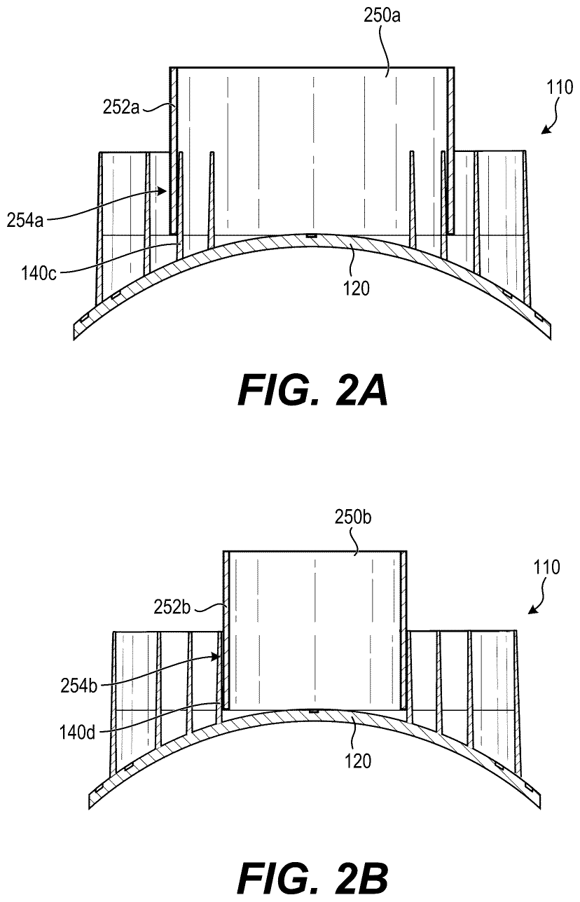

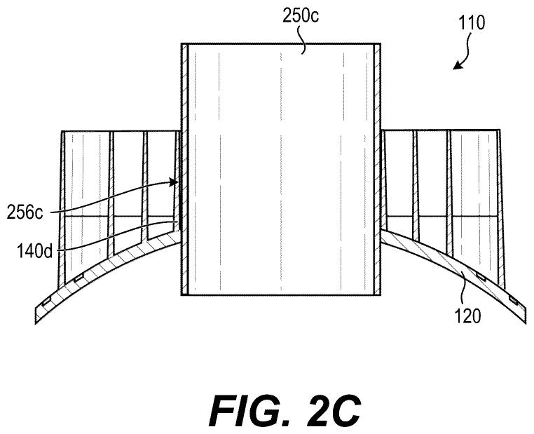

In disclosed embodiments, each of the concentric rings may be configured to accommodate, or connect to, fluid pipes of different sizes. For example, FIG. 2A depicts adapter 110 with a pipe 250a coupled to the third ring 140c. In this example, the sidewall 252a of the pipe may be mounted on the external surface of the third ring 140c and secured in a fluid-tight manner via, e.g., a gasketed connection, an elastomeric seal, a glue connection, a primer connection, a solvent welded connection, one or more mechanical fasteners, or by friction fit. In some embodiments, the connection between the ring and the pipe may be a permanent or fixed connection. Alternatively, the pipe may be detachably coupled to the ring. As another example, FIG. 2B shows adapter 110 with a second pipe 250b coupled to the innermost, fourth ring 140d. Second pipe 250b may have a smaller diameter than the first pipe 250a, such that the second pipe 250b connects to a smaller ring on the adapter 110. In the example shown in FIG. 2B, the second pipe 250b may be mounted inside the ring 140d, with the pipe's sidewall 252b nested against the interior surface of ring 140d and secured via, e.g., friction fit, adhesive, or a mechanical fastener.

The concentric rings 140 of adapter 110 may be connected to a pipe at any suitable location along said pipe. In some embodiments, adapter 110 may be configured to receive, and be connected to, an end portion of a pipe. For example, FIGS. 2A and 2B depict embodiments in which adapter 110 is connected to end portions 254a, 254b of pipes 250a, 250b, respectively. Additionally, or alternatively, adapter 110 may also be configured to receive, and to be connected to, a middle portion of a pipe. For example, FIG. 2C depicts an embodiment in which adapter 110 is connected to a middle portion 256c of a pipe 250c.

The concentric rings 140 of adapter 110 are configured to accommodate (that is, form a secure and fluid-tight connection with) a variety of types of fluid pipes, including corrugated pipes, smooth wall pipes, single wall pipes, dual wall pipes, and triple wall pipes. Concentric rings 140 may also accommodate fluid pipes constructed from any suitable material, including polyethylene, polypropylene, resin, metal, and reinforced concrete.

Advantageously, the plurality of concentric rings 140 allow adapter 110 to accommodate (that is, form a secure and fluid-tight connection with) pipes of different sizes or diameters. As a result, the fluid basin 460 may be fluidly connected, via adapter 110, to pipes of various sizes, unlike previous catch basins that only connect to pipes of a single size. In some embodiments, the inner and/or outer diameters of each of the plurality of concentric rings 140 may be selected to accommodate pipes of any desired size, such as pipes with an outer diameter or inner diameter of about 4 inches, 6 inches, 8 inches, 10 inches, 12 inches, 14 inches, 15 inches, 16 inches, 18 inches, 20 inches, 21 inches, 24 inches, or 36 inches.

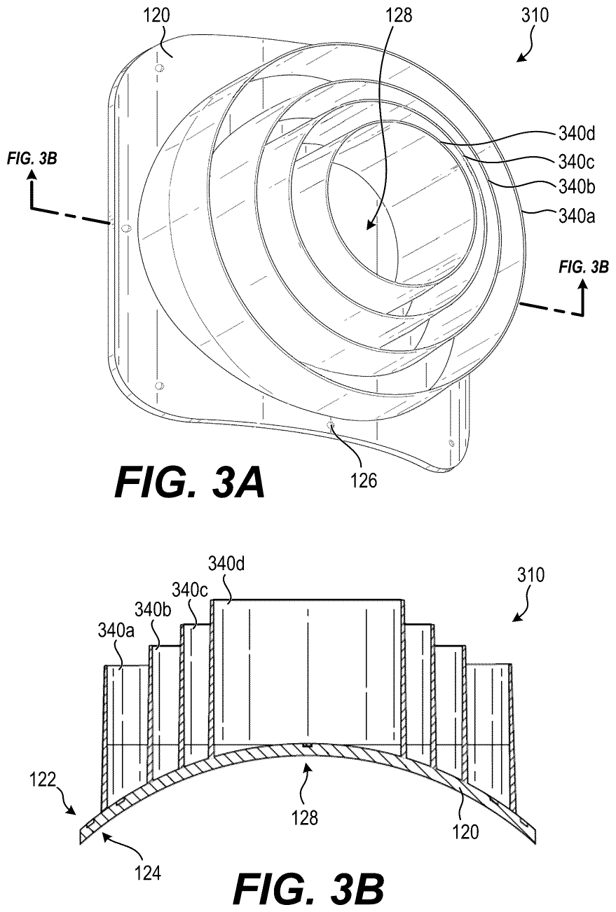

In some embodiments, some or all of the plurality of rings may have the same height, such that the outer ends of the rings are arranged along a common axis. For example, FIG. 1D depicts an adapter 110 with rings 140a, 140b, 140c, and 140d having the same height. That is, the outer ends of the rings 140a-140d are all arranged along a common axis A. In alternative embodiments, some or all of the plurality of rings may have different heights, such that some rings extend further out from the plate than other rings. For example, FIGS. 3A and 3B show an adapter 310 with four rings 340a, 340b, 340c, and 340d, which are progressively greater in height. In the example shown, the outer-most ring 340a may have the largest diameter and the smallest height, while the inner-most ring 340d may have the smallest diameter and the greatest height. In some embodiments, the concentric rings may have straight or flat inner and outer surfaces. Alternatively, some or all of the concentric rings may be tapered, such that the outer end of the ring (i.e., the end furthest from the plate) is less thick than the inner end of the ring. Additionally, or alternatively, some or all of the concentric rings may have a stepped inner and/or outer surface.

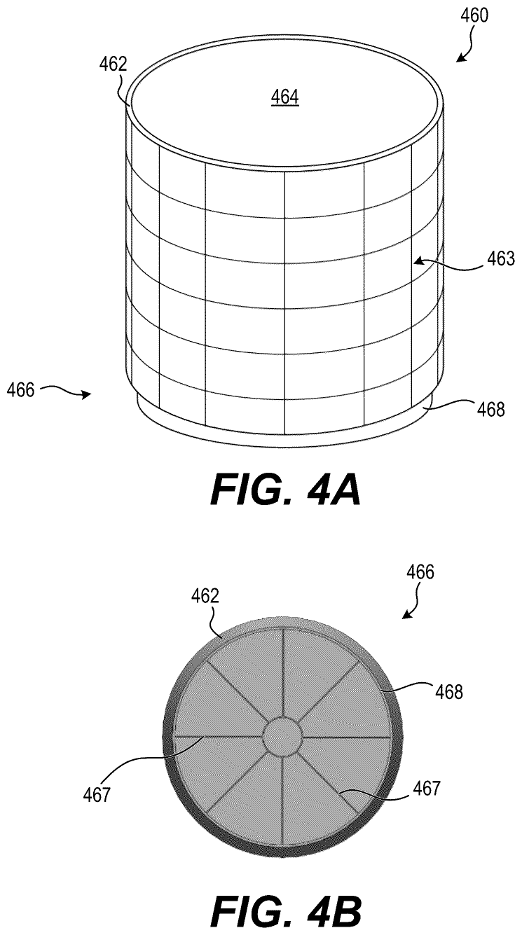

FIGS. 4A and 4B depict an embodiment of a fluid basin 460 configured to catch and/or store fluids such as stormwater and run-off. For example, fluid basin 460 may be a catch basin configured for placement underground to collect stormwater. Fluid basin 460 may include a cylindrical side wall 462 encompassing a hollow interior volume 464, an enclosed bottom portion 466 at a first end, and optionally a cover or drain (not shown) at a second end. In some embodiments, bottom portion 466 may be integrated with (e.g., manufactured integrally with) the rest of the fluid basin 460. Alternatively, bottom portion 466 may be manufactured separately and connected to the side wall 462 to form the fluid basin. In some embodiments, the bottom portion 466 may include at least one reinforcing rib 467 to structurally support the fluid basin. Additionally, the bottom portion 466 may include a recessed rim or lip 468 allowing the fluid basin to be easily stacked on top of another fluid basin. In some embodiments, fluid basin 460 may have a height of between 24 inches and 36 inches. In some embodiments, fluid basin 460 may have an outer diameter of approximately 24 inches. For example, fluid basin 460 may have an outer diameter of between 23.5 inches and 25.5 inches. Alternatively, fluid basin 460 may have a different outer diameter, such as an outer diameter of approximately 30 inches, approximately 36 inches, approximately 48 inches, or any other desired diameter or size.

In disclosed embodiments, fluid basin 460 may be connected to one or more fluid pipes to allow fluid to flow into and/or out of the fluid basin 460 via the fluid pipe(s). For example, fluid basin 460 may be connected to one or more fluid delivery pipes, which may deliver fluid into the basin interior 464. Additionally, or alternatively, fluid basin 460 may be connected to one or more fluid drainage pipes, so that fluid accumulated within the basin interior 464 may flow out of the basin and be carried away by the fluid drainage pipe(s) (e.g., to a sewer system or to a body of water). In contrast to catch basins with pre-fabricated pipe connections, fluid basin 460 may be customizable, insofar as a pipe connection may be formed at any part of the basin's side wall 462. Specifically, and as discussed in further detail below in reference to FIGS. 5 and 6, a pipe connection may be formed by mounting the adapter 110 at any desired position on fluid basin 460, and then by attaching a pipe to the adapter 110. Adapter 110 (and thus, the attached pipe) may be connected to the basin 460 at any height and at any point along the circumference of the basin's side wall 462. However, a user may wish to avoid placing adapter 110 at a position that is too high or too low on fluid basin 460, so that the entire second surface 124 of the adapter may be placed in contact with the basin's side wall 462. In some embodiments, at least a portion of the outer surface of side wall 462 may be embossed with a grid design 463 designating various locations for mounting the adapter 110. Since adapter 110 is configured to receive pipes of various sizes due to the different diameters of rings 140a-140d, fluid basin 460 is configured to connect to fluid pipes of different sizes via the adapter 110.

FIGS. 5 and 6 depict an embodiment of a fluid drainage system 500 including an adapter 110, a fluid basin 460, and a fluid pipe 550, which may be configured as a fluid delivery pipe or as a fluid drainage pipe. As shown, adapter 110 may be configured to connect, and to form a fluid connection between, the fluid basin 460 and the pipe 550. Once assembled, system 500 may be installed in the ground (or at any other desired location) to catch, store, and ultimately drain away stormwater and other fluids. Although the following discussion of system 500 refers to adapter 110 of FIGS. 1A-1D, adapter 310 of FIGS. 3A-3B may alternatively be used with system 500 in a similar manner. Further, in some embodiments, adapter 110 may be configured to attach a fluid pipe 550 to another fluid basin or container, so long as the curvature of the outer surface of that fluid basin or container corresponds to the curvature of plate 120 (as discussed above).

As shown in the exploded view of system 500 in FIG. 6, at least a first fluid opening 570 may be formed through the side wall 462 of fluid basin 460. First fluid opening 570 may be formed by known techniques, such as cutting or drilling. A second fluid opening 530 may also be formed in the plate 120 of adapter 110. Specifically, second fluid opening 530 may be formed in the center portion 128 of the plate, at a position corresponding to the center of the plurality of concentric rings 140. Some or all of the center portion 128 may be trimmed or knocked-out with a hammer, drill, saw, hole-punch, or another suitable technique to the desired size. In some embodiments, a user may select the respective sizes of first fluid opening 570 and second fluid opening 530 based on, e.g., an expected volume of fluid or a size of a pipe 550 to be mounted on one of the concentric rings of adapter 110.

Adapter 110 may then be mounted on the outer surface of side wall 462, at a position in which the second fluid opening 530 overlies the first fluid opening 570. Plate 120 of the adapter may then be affixed to the outer surface of the fluid basin 460 by one or more of mechanical connector(s), cement, adhesive, or any other suitable means. In some embodiments, a cement or adhesive may be applied to the rear surface 124 of the plate in a continuous manner (i.e., without gaps or interruptions) along the outer edge of the plate. Once the plate 120 is mounted on the outer surface of basin 460, the cement or adhesive forms a fluid-tight seal between plate 120 and the basin side wall 462, thus preventing leakage of fluid flowing between the first and second fluid openings. Fluid pipe 550 may also be mounted on the appropriate one of the concentric rings of adapter 110 (in the example shown in FIGS. 5 and 6, pipe 550 may be mounted on the inner-most ring 140d). As discussed above, pipe 550 may be secured to the ring in a fluid-tight manner, thus providing a fluid-tight connection between the fluid pipe 550 and the interior volume 464 of the fluid basin. Fluid may then flow between basin 460 and the attached pipe 550 via the first fluid opening 570 and second fluid opening 530.

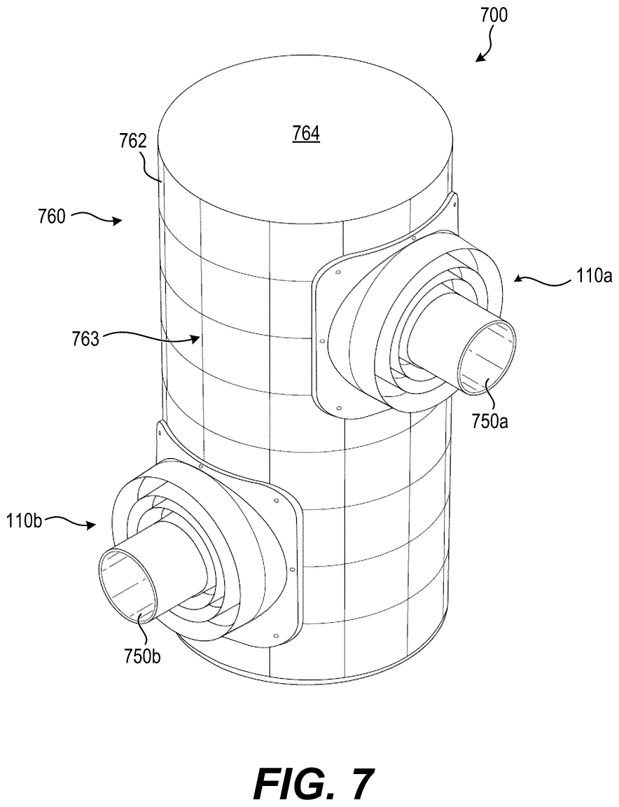

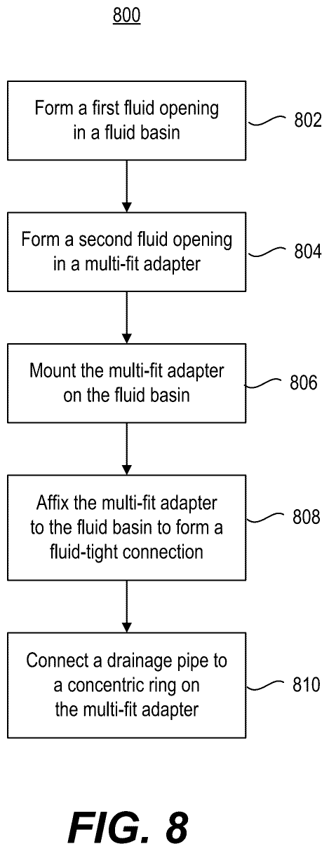

In disclosed embodiments, multiple adapters may be used to fluidly connect multiple pipes to a single fluid basin. For example, FIG. 7 illustrates another embodiment of a fluid drainage system 700 including a fluid basin 760, a first adapter 110a for connecting a first pipe 750a to fluid basin 760, and a second adapter 110b for connecting a second pipe 750b to fluid basin 760. First adapter 110a and second adapter 110b may be individually placed at the desired positions on fluid basin 760, optionally by using embossed grid design 763 to help place and orient the adapters on side wall 762. First adapter 110a and second adapter 110b may be used to fluidly connect pipes 750a and 750b to interior volume 764 of fluid basin 760. Pipes 750a and 750b may have the same size or different sizes. In some embodiments, one or both pipes 750a, 750b may be drainage pipes used to drain fluid accumulated within fluid basin 760. Alternatively, one or both pipes 750a, 750b may be delivery pipes used to deliver fluid into the interior volume 764 of fluid basin 760.

Advantageously, adapter 110 allows for customization of both the number and location(s) of pipe connections to fluid basin 460, while also providing connection to pipes of different sizes via the plurality of rings 140. As a result, users can assemble a customized fluid drainage system that best suits the topography of the land and the volume of fluid (e.g., rainwater) to be caught and drained away. Additionally, adapter 110 can be used to connect a fluid basin to a previously-installed pipe. For example, when a fluid pipe is already installed in the ground, a fluid basin (e.g., basin 460) may be placed at or near an exposed end of the pipe, and an adapter 110 may be used to connect the fluid basin to the exposed end of the pipe. Since adapter 110 allows the previously-installed pipe to be connected to any part of the fluid basin (rather than connecting to a single, pre-fabricated fluid connector), the pipe does not need to be dug-up or repositioned to achieve the connection with the fluid basin.

FIG. 8 illustrates a first embodiment of a method 800 of assembling a fluid drainage system. Step 802 includes forming at least a first fluid opening in a fluid basin. As an example, FIG. 6 depicts a first fluid opening 570 formed in the side wall 462 of a fluid basin 460. Step 804 includes forming a second fluid opening in a multi-fit adapter. That is, the second fluid opening may be formed in the multi-fit adapter before mounting the multi-fit adapter on the fluid basin. In disclosed embodiments, the multi-fit adapter includes a plurality of concentric rings configured to accommodate fluid pipes of different sizes. As an example, FIG. 6 shows adapter 110 with a second fluid opening 530 formed in center portion 128. Step 806 includes mounting the multi-fit adapter on the outer surface of the fluid basin. In disclosed embodiments, the adapter may be mounted so that the second fluid opening directly overlays the first fluid opening. Step 808 includes affixing the multi-fit adapter to the fluid basin to form a fluid-tight connection between the adapter and the fluid basin. Step 810 includes connecting a fluid pipe to one of the concentric rings on the multi-fit adapter. As a result, a fluid-tight path of flow (i.e., a fluid path) is provided between the interior of the fluid basin and the attached fluid pipe, such that fluid may flow from the fluid basin into the attached fluid pipe or vice versa.

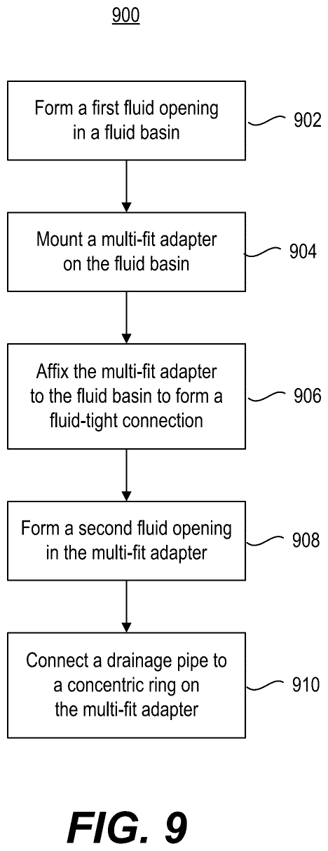

FIG. 9 illustrates a second embodiment of a method 900 of assembling a fluid drainage system. Step 902, similar to step 802 discussed above, includes forming at least a first fluid opening in a fluid basin. However, step 904 includes mounting a multi-fit adapter on the fluid basin before forming a second fluid opening in the adapter. Step 906 includes affixing the multi-fit adapter to the fluid basin to form a fluid-tight connection. Then, step 908 includes forming a second fluid opening in the multi-fit adapter (e.g., by trimming or knocking out). That is, the second fluid opening may be formed in the multi-fit adapter after mounting the multi-fit adapter on the fluid basin. Step 910 includes connecting a fluid pipe to one of the concentric rings on the multi-fit adapter. As a result, a fluid-tight path of flow is provided between the interior of the fluid basin and the attached fluid pipe.

In some embodiments, methods 800 and 900 may include additional steps for attaching additional adapters and pipes to the fluid basin. For example, either of methods 800 and 900 may include additional steps of forming a third fluid opening in the fluid basin; mounting a second multi-fit adapter on the outer surface of the fluid basin; forming a fourth fluid opening in the second multi-fit adapter; and connecting a second fluid pipe to one of the concentric rings of the second multi-fit adapter. As a result, an additional fluid path may be formed between the interior of the fluid basin and the second fluid pipe through the third fluid opening and fourth fluid opening. As an example, FIG. 7 depicts a first multi-fit adapter 110a and a first pipe 750a mounted on a fluid basin 760, as well as a second multi-fit adapter 110b and a second pipe 750b mounted on the fluid basin 760. In some embodiments, even more pipes may be similarly connected to the fluid basin using additional multi-fit adapters.

Some embodiments of the present disclosure described herein describe a multi-fit adapter configured to fluidly connect one or more pipes or tubes to a basin for accumulating and storing water, such as a stormwater catch basin. However, it should be understood that the multi-fit adapter described herein may also be configured to fluidly connect one or more pipes or tubes to any suitable container or vessel for holding or conveying fluids, such as barrels, fluid-storage chambers, water drain basins, containers and vessels for water management solutions (such as water treatment and filtration containers, stormwater detention/retention chambers, and sump basins), and other pipes and tubes.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. While certain components have been described as being coupled to one another, such components may be integrated with one another or distributed in any suitable fashion.

Although this disclosure has been shown and described with respect to the detailed embodiments thereof, it will be understood by those of skill in the art that various changes may be made and that equivalents, modifications, omissions, combinations (e.g., of aspects across various embodiments), adaptations and/or alterations may be added to and/or substituted for elements thereof without departing from the scope of the disclosure. The elements in the claims are to be interpreted broadly based on the language employed in the claims and not limited to examples described in the present specification or during the prosecution of the application, which examples are to be construed as nonexclusive. In addition, modifications may be made to adapt a particular situation or material to the teachings of the disclosure without departing from the essential scope thereof. Further, the steps of the disclosed methods can be modified in any manner, including reordering steps and/or inserting or deleting steps. Therefore, it is intended that the scope of the appended claims not be limited to the particular embodiments disclosed in the above detailed description, but that the scope of the appended claims will include all embodiments falling within the scope of this disclosure.

Other embodiments will be apparent from consideration of the specification and practice of the embodiments disclosed herein. It is intended that the specification and examples be considered as example only, with a true scope and spirit of the disclosed embodiments being indicated by the following claims.

1. A multi-fit adapter for a fluid basin, the adapter comprising:
a plate configured to be mounted on an outer surface of the fluid basin; and
a plurality of concentric rings protruding from the plate,
wherein a curvature of the plate corresponds to a curvature of the outer surface of the fluid basin, and
wherein each of the plurality of concentric rings is configured to accommodate a fluid pipe.

2. The multi-fit adapter of claim 1, wherein the plurality of concentric rings protrude from a curved first surface of the plate.

3. The multi-fit adapter of claim 2, wherein a second surface of the plate is configured to be positioned flush with the outer surface of the fluid basin.

4. The multi-fit adapter of claim 1, wherein the multi-fit adapter is configured to be affixed to the outer surface of the fluid basin to provide a fluid-tight connection between the fluid pipe and an interior volume of the fluid basin.

5. The multi-fit adapter of claim 1,
wherein the at least one concentric ring includes an internal surface of a first diameter and an external surface of a second diameter, and
wherein the internal surface of the at least one concentric ring is configured to couple to the fluid pipe.

6. The multi-fit adapter of claim 1,
wherein the at least one concentric ring includes an internal surface of a first diameter and an external surface of a second diameter, and
wherein the external surface of the at least one concentric ring is configured to couple to the fluid pipe.

7. The multi-fit adapter of claim 1, wherein the concentric rings are configured to couple to fluid pipes of different sizes.

8. The multi-fit adapter of claim 1, wherein the plate is configured to be mounted on the outer surface of the fluid basin at any position along the circumference of the fluid basin.

9. The multi-fit adapter of claim 1, wherein the plate is configured to be positioned over a fluid opening in a side wall of the fluid basin.

10. The multi-fit adapter of claim 1, wherein the plate includes a center portion at a position corresponding to a center of the concentric rings, wherein the multi-fit adapter is configured for formation of a fluid opening in the center portion of the plate.

11. The multi-fit adapter of claim 1, wherein the plate and the plurality of concentric rings are constructed from the same material.

12. The multi-fit adapter of claim 1, wherein the fluid basin has an outer diameter of approximately 24 inches.

13. The multi-fit adapter of claim 1, wherein at least one of the plurality of concentric rings is configured to accommodate a pipe for delivering fluid into the fluid basin.

14. The multi-fit adapter of claim 1, wherein at least one of the plurality of concentric rings is configured to accommodate a pipe for draining fluid from the fluid basin.

15.-32. (canceled)
